(19) United States
(12) Patent Application Publication
(10) Pub. No.: US 2019/0384638 A1
(43) Pub. Date: Dec. 19, 2019

(54) METHOD, DEVICE AND COMPUTER PROGRAM PRODUCT FOR DATA PROCESSING

(71) Applicant: EMC IP Holding Company LLC, Hopkinton, MA (US)

(72) Inventors: Tao Chen, Tel Aviv (IL); Bing Liu, Chengdu Sichuan (IL); Cheng Ye, Hopkinto, MA (US)

(21) Appl. No.: 16/146,816

(22) Filed: Sep. 28, 2018

(30) Foreign Application Priority Data
Jun. 15, 2018 (CN) 201810619242.7

(51) Int. Cl. G06F 9/50; G06F 12/1045; G06F 12/1009; G06F 12/14

(52) U.S. Cl. CPC G06F 9/5016; G06F 12/1063; G06F 12/1009; G06F 2212/402; G06F 12/145; G06F 2212/401; G06F 12/1408

(57) ABSTRACT

Embodiments of the present disclosure are intended to provide a method, device and computer program product. The method comprises: creating a memory pool for an application, the memory pool comprising at least one page with contiguous physical addresses; determining information of a buffer for storing data of the application; and in response to a compression or encryption operation to be executed for the data, determining, based on the information of the buffer, a page section of the at least one page corresponding to the buffer for the execution of the compression or encryption operation. On one hand, the method of data processing is provide in the embodiments of the present disclosure may meet the storage requirements of a QAT and on the other hand, the method of data processing may save the overhead of the system and optimize the system performance.

### FIELD

Embodiments of the present disclosure generally relate to data processing, and more specifically, to a method, device and computer program product for data processing.

### BACKGROUND

As the complexity of applications continues to grow, systems require more and more computing resources of workloads, including cryptography and data compression. The Intel's QuickAssist Technology (QAT) provides security and compression acceleration to improve performance and efficiency of Intel architecture platforms. The Intel QAT hardware-assisted engines work may reserve processor cycles for application processing, which not only reduces CPU load and but also improves the overall system performance, especially for a computing-intensive solutions.

However, in order to support QAT, applications have to rely on additional user space libraries and a kernel module provided by Intel to meet storage requirements of the QAT. For example, the Intel QAT is implemented in hardware as a device that uses Direct Memory Access (DMA) to access data in the Dynamic Random Access Memory (DRAM), and, thus, the data to be run thereon must be in a DMA-able memory. This means that the data must be stored in locked pages, and the pages must be physically contiguous. Alternatively, applications can pass data in multiple regions as described in a scatter-gather-list. In addition, Intel QAT Application Interfaces (APIs) require applications to provide a callback function to translate a virtual address for each buffer to be run to a physical address.

The convention approach is using the copy buffers. For example, an application allocates a specific physically contiguous storage buffer from a memory allocator and uses these buffers as copy buffers. Prior to passing data to the QAT, the applications need to copy data from their generic buffer to the copy buffers. The memory allocator guarantees that these copy buffers are physically contiguous and provide physical addresses to applications. However, this approach requires a high system overhead related to copying data to the copy buffers, and the application needs to protect the copy buffer shared with the QAT thread, for example, by locking the copy buffer, which may cause system performance bottlenecks.

### SUMMARY

Embodiments of the present disclosure may provide solutions to one or more of the aforementioned limitations of the prior art.

One aspect of the present disclosure provides a method of data processing. The method comprises: creating a memory pool for an application, the memory pool comprising at least one page with contiguous physical addresses; determining information of a buffer for storing data of the application; and in response to a compression or encryption operation to be executed for the data, determining, based on the information of the buffer, a page section of the at least one page corresponding to the buffer for the execution of the compression or encryption operation.

One aspect of the present disclosure provides a device for data processing. The device comprises at least one processor and a memory coupled to the at least one processor. The memory includes instructions stored therein, and the instructions, when executed by the at least one processor, causes the device to create a memory pool for an application, the memory pool comprising at least one page with contiguous physical addresses; determine information of a buffer for storing data of the application; and in response to a compression or encryption operation to be executed for the data, determine, based on the information of the buffer, a page section of the at least one page corresponding to the buffer for the execution of the compression or encryption operation.

One aspect of the present disclosure provides a computer program product, which is tangibly stored in a non-transient computer readable medium and includes at least one machine executable instruction, and the at least one machine executable instruction, when executed, causes a machine to execute steps of the method described above.

This Summary is provided to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the following detailed description with reference to the accompanying drawings, the above and other objectives, features, and advantages of example embodiments of the present disclosure will become more apparent. Several example embodiments of the present disclosure will be illustrated by way of example but not limitation in the drawings in which:

FIG. 1 illustrates a diagram of architecture of a data domain file system (DDFS) using QAT according to some embodiments.

FIG. 2 illustrates a memory pool having copy buffers according to some embodiments.

FIG. 3 illustrates a diagram of an example scenario that can implement embodiments of the present disclosure.

FIG. 4 illustrates a flowchart of a method according to embodiments of the present disclosure.

FIG. 5 illustrates a diagram of a corresponding relationship between a buffer and a page according to embodiments of the present disclosure.

FIG. 6 illustrates a schematic block diagram of a device for implementing embodiments of the present disclosure.

Throughout the drawings, the same or similar reference symbols refer to the same or similar elements.

### DETAILED DESCRIPTION OF EMBODIMENTS

Various example embodiments of the present disclosure will be described below with reference to the accompanying drawings. It would be appreciated that these drawings and description are only about example embodiments. It should be pointed out that alternative embodiments of the structure and method disclosed herein would be readily envisioned according to the subsequent description, and these alternative embodiments may be employed without departing from principles as claimed herein.

It is to be understood these implementations are discussed only for the purpose of enabling those skilled persons in the art to better understand and thus implement the present disclosure, rather than suggesting any limitations on the scope of the subject matter described herein.

As used herein, the term “includes”, “comprises” and its variants are to be read as open-ended terms that mean “includes/comprises, but is not limited to.” The term “based on” is to be read as “based at least in part on.” The term “some example embodiments” is to be read as “at least some example embodiments”; and the term “another embodiment” is to be read as “at least one another embodiment”. Relevant definitions of other terms may be included below.

Currently, Intel QuickAssist Technology (QAT) provides security and compression acceleration functions, so as to improve the performance and efficiency of Intel architecture platforms. In order to support QAT, applications need to rely on additional user space libraries and a kernel module provided by Intel to meet the storage requirements of QAT.

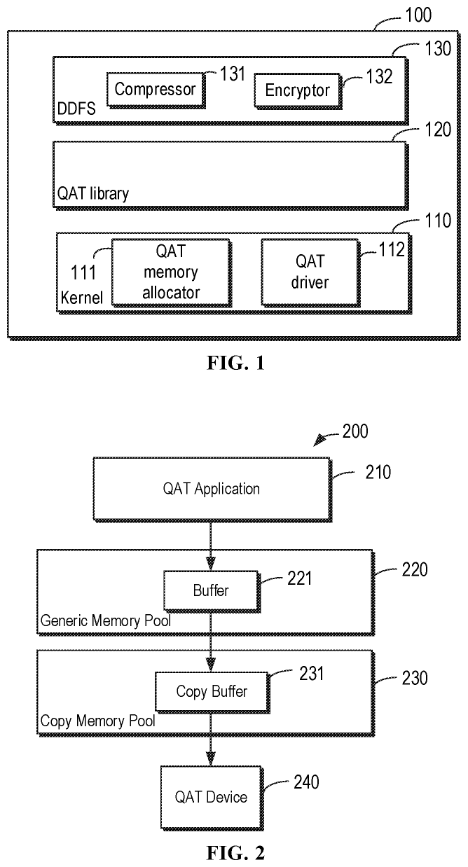

FIG. 1 illustrates a diagram of architecture 100 of a data domain file system using QAT according to some embodiments. As shown in FIG. 1, the architecture 100 includes a kernel 110, a QAT library 120 and a changing DDFS 130. The kernel 110 includes a QAT memory allocator 111 and a QAT driver 112. The changing DDFS 130 includes a compressor 131 using QAT and an encryptor 132 using QAT. The QAT memory allocator 111 is provided for allocating the memory space for QAT. In other words, in order to support QAT, applications need to rely on additional user space libraries and a kernel module provided by the Intel to satisfy the storage requirements of QAT.

In general, the storage requirements of QAT include the following aspects. First, the Intel QAT is implemented in hardware as a device that uses a Direct Memory Access (DMA) to access data in a Dynamic Random Access Memory (DRAM) and, therefore, data to be run thereon must be located in a DMA-able memory. This means that the data must be stored in the locked pages that are also physically contiguous. Alternatively, applications can pass data in a plurality of regions as described in a scatter-gather list. Second, because the QAT uses DMA to access the buffers, all pages of the buffers are required to always be physically in a Random Access Memory (RAM) of the system. In addition, the Intel QAT Application Interfaces (APIs) require applications to provide a callback function in order to translate a virtual address of each buffer into a physical address. That is, a correspondence relationship between a physical address and a virtual address must be obtained.

In addition to meeting the above requirements, in order to achieve better performance, memory allocation and address translation must be low cost. For each physical address of the buffer that QAT wants to know each time the address translation callback function. For example, a single invocation of the QAT compression or encryption of API may lead to the virtual-to-physical translation callback function to be invoked multiple times.

The convention approach is using the copy buffers. For example, an application allocates a specific physically contiguous storage buffer from a memory allocator and uses these buffers as copy buffers. Prior to passing data to the QAT, the applications need to copy data from their generic buffer to the copy buffers. The memory allocator guarantees that these copy buffers are physically contiguous and provides the physical addresses to applications.

FIG. 2 illustrates a memory pool model 200 having copy buffers according to some embodiments. FIG. 2 shows a generic memory pool 200 and a copy memory pool 230 between a QAT application 210 and a QAT device 240. The copy memory pool 230 is a physically contiguous memory space allocated by the system. The QAT application 210 fills data in a buffer 221 on the generic memory pool 220, and before transmitting of the data to the QAT device 240, the data is copied from the buffer 221 to the copy buffer 231 on the memory pool 230 in order to ensure that the buffers filled with data is physically contiguous.

This approach requires a high system overhead related to copying the buffers, and related to the application's need to protect the copy buffer shared with the QAT thread, for example, by locking the copy buffer, which may cause system performance bottlenecks.

Therefore, the present disclosure provides a method for data processing, which can meet the storage requirements of QAT as mentioned above, and can decrease the system overhead and optimize system performance.

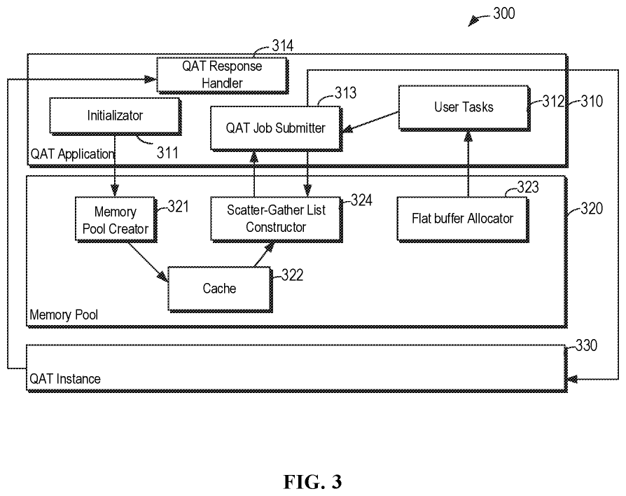

FIG. 3 illustrates a diagram of an example scenario 300 that can implement embodiments of the present disclosure. As shown in FIG. 3, the scenario 300 includes a QAT application 310, a memory pool 320 and a QAT instance 330. The term “QAT instance” used herein refers to be a device or entity for processing data using QAT.

The QAT application 310 includes an initiator 311 for determining a storage budget of the memory pool 320 prior to creating the memory pool 320. A memory creator 321 in the memory pool 320 creates a memory pool based on the determined storage budget. The memory pool may be regarded as a dedicated memory pool for the QAT application 310 allocated by the file system. The memory pool may include at least one page. The physical addresses within each page are contiguous.

A cache 322 is also created in the procedure of creating the memory pool 320. The cache 322 is provided for storing an entry reflecting a mapping relationship between the physical address in the page of the memory pool 320 and the virtual address of the QAT application 310. When creating the memory pool 320, all pages in the memory pool 320 are iterated, and a page mapping file is searched through the file system to translate their virtual addresses into physical addresses. In other words, once the mapping relationship is generated between the virtual address of the QAT application 310 and the physical address in the page of the memory pool 320, the mapping relationship is inserted as an entry of the cache 322.

The term “page” in the embodiments of the present disclosure may be a large page of 2 MB, for example. That is, for example, if the storage budget of the memory pool 320 is 20 MB, the memory pool 320 can include ten 2 MB pages, and the buffers in each large page of 2 MB is physically contiguous. In other embodiments of the present disclosure the term “page” may be a generic page of 4 kB, for example. As compared to the case of using the generic page of 4 kB, using the large page of 2 MB may allow the size of the translated cache smaller. Of course, the term “page” may be selected as a large page of 1 GB, for example. It would be appreciated that a page of any size suitable for the application and the system can be selected as a page in the memory pool 320.

When the QAT application 310 intends to implement the user tasks by using a memory space in the memory pool 320, for example, to implement the data storage, the user task 312 of the QAT application 310 requests a memory space from the memory pool 320. The buffer allocator 323 in the memory pool 320 allocates a buffer to the QAT application 310, for data storage. The buffer for the QAT application 310 allocated by the buffer allocator 323 is regarded herein as a flat buffer. In the present disclosure, the term “flat buffer” is a flat binary cache (in several arrays) for holding data hierarchy, which is capable of maintaining direct access to the data structure therein without parsing, and can ensure a compatibility before and after the data structure is changed.

When the QAT application 310 desires to perform data processing, a task is initiated by a QAT task submitter 313 in the QAT application 310. The term “data processing” used herein can include, but is not limited to, at least one of data encryption, data decryption, data compression and data decompression. As mentioned above, due to the storage requirements of the QAT, buffers provided to a QAT instance have to be physically contiguous. Therefore, the QAT task submitter 313 takes the buffers as inputs, and a scatter-gather-list to be provided to the QAT instance 330 is generated through a scatter-gather-list constructor 323 and the cache 322 in the memory pool 320.

The term “scatter-gather-list” used herein is to be read as gathering page sections (segments) in a page in the memory pool 320 corresponding to the buffer. Each page section serves as an entry in the scatter-gather-list, and the physical addresses on each page section is contiguous. The scatter-gather-list further includes a list header for storing a start physical address and a size of each page section. Translation from the buffer to the scatter-gather-list is further described below in detail.

The scatter list constructor 323 submits the scatter-gather-list to the QAT instance 330, to enable the QAT instance 330 to process the data, for example, to encrypt or compress data, or the like. Upon completing the data processing, the QAT instance 330 notifies a QAT response handler 314 therein that the data processing has been completed.

By proposing the memory pool 320 as shown in FIG. 3, the present disclosure can satisfy a storage requirements of the QAT, and decrease or eliminate system overhead caused by the buffer copy operation in the conventional solution. In addition, the proposed memory pool further solves the problem of platform compatibility.

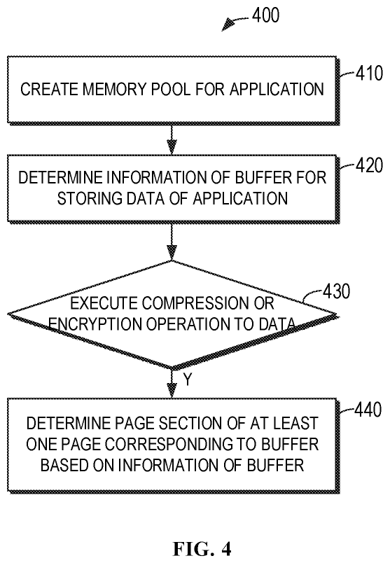

The method according to embodiments of the present disclosure will be further described in detail with reference to FIGS. 4-6. FIG. 4 illustrates a flowchart of a method 400 according to embodiments of the present disclosure. The method as shown in FIG. 4 is applicable to the scenario 300 as described in FIG. 3. For the sake of description, reference signs consistent to those in FIG. 3 are employed in FIG. 4 for the same or similar components. At block 410, a memory pool 320 for an application is created. The capacity of the created memory pool 320 may be determined according to pre-determined capacity requirements of the application 310. The memory pool 320 includes therein at least one page which has contiguous physical addresses. As mentioned above, the page(s) included in the memory pool 320 may be of a predetermined page size.

According to some embodiments, creating the memory pool 320 includes determining a cache 322 from the memory pool 320 and determining a mapping relationship between the physical address of the at least one page in the memory pool 320 and the virtual address of the application 310. The determined mapping relationship is stored as an entry of the cache 322.

According to some embodiments, determining the mapping relationship may be implemented by mapping the at least one page to an address space of the application 310. By creating the mapping relationship between the at least one page and the address space of the application 310, a start virtual address of the at least one page can be obtained. After obtaining the start virtual address, each page from the at least one page in the memory pool 320 may be iterated, so as to determine a respective physical address of each page from the at least page based on the start virtual address, a base address of the memory pool 320 and an offset of each page in the memory pool 320. The mapping relationship can be generated based on the determined physical address. The mapping relationship can be stored in the cache 322 as an entry of the cache 322.

According to some embodiments, the entry of the mapping relationship in the cache 322 may be presented in the form of hash table.

According to some embodiments, determining a respective physical address of each page can be implemented by reading a page mapping file in the file system.

As indicated above, according to the storage requirements of the QAT, the pages in the memory pool are required to be locked in the memory pool. In other words, it is not allowed that data on the pages are flushed to other memory spaces to release the pages. Hence, according to some embodiments, creating the memory pool 320 for the application 310 may further include locking the at least one page in the memory pool 320.

For the operation of locking pages, it may be implemented after iterating each page of the at least one page as described above. For example, after determining a respective physical address of a first page in the at least one page, the first page is locked in the memory pool 320. According to some embodiments, after determining a respective physical address of each page of the at least one page, each page of the at least one page may be iterated again, so as to lock each page in the memory pool 320.

Through the improved memory pool as proposed in the embodiments of the present disclosure, the present disclosure can satisfy the storage requirements of the QAT, and decrease or eliminate the system overhead caused by the buffer copy operation in the conventional solution.

Referring to FIG. 4 again, at block 420, buffer information for storing data of the application 310 is determined. According to some embodiments, the buffer information may, for example, include at least one of a size of buffer and a start virtual address of the buffer.

At block 430, it is determined whether an encryption or compression operation is executed for data. In some embodiments, it may be determined, for example, by determining whether the QAT task submitter 313 issues a request for submitting a QAT task to the QAT instance 330.

If it is determined to execute the encryption or compression operation for the data, at block 430, a page section in the at least one page corresponding to the buffer is determined based on the information of the buffer, at block 440.

According to some embodiments, determining the page section of the at least one page corresponding to the buffer may comprise determining the start virtual address of the buffer and the size of buffer. According to the mapping relationship in the cache 322, a respective physical address may be determined based on the start virtual address. Based on the size of buffer, it can be determined that the buffer is covered in a page, or the buffer extends beyond a page, thereby determining the page section of the at least one page corresponding to the buffer.

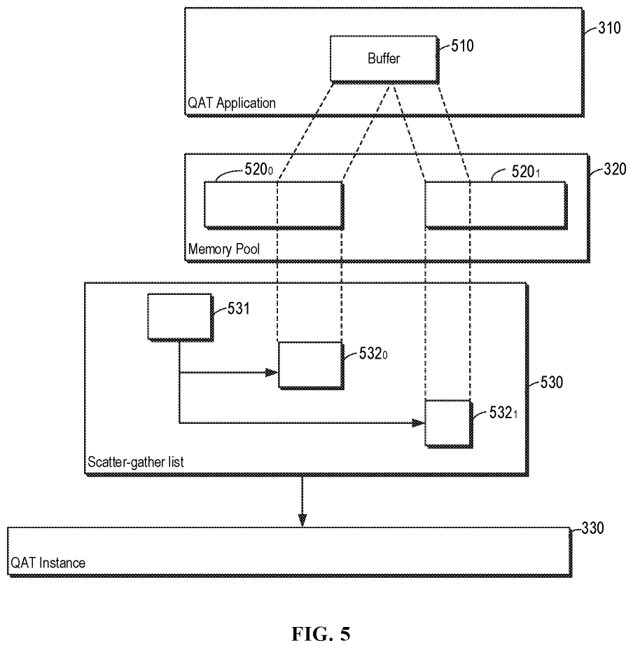

Determining the page section corresponding to the buffer may be further described in detail with reference to FIG. 5. FIG. 5 illustrates a diagram of a mapping relationship between the buffer and the page in the embodiments of the present disclosure.

As shown in FIG. 5, a buffer 510 in the QAT application 310 can correspond to a page in the memory pool 320. As described above, a respective physical address may be obtained based on a start virtual address of the buffer 510 and the cache (not shown inn FIG. 5) preserved previously in the memory pool 320, so as to determine a page corresponding to the buffer, for example a page 520₀ in FIG. 5. Based on the size of the buffer 510, it is determined whether the buffer 510 extends beyond the page 520₀. FIG. 5 shows a case of extending beyond the page 520₀. As shown in FIG. 5, the buffer 510 further corresponds to a section of page in the page 520₁. Therefore, in FIG. 5, the page 520₀ and the page 520₁ have a respective page section corresponding to the buffer 510. The two page sections are determined as page sections corresponding to the buffer 510.

As described above, the page section to be provided to the QAT instance 330 can be presented in the form of scatter-gather-list 530. Continuing to refer to FIG. 5, the scatter-gather-list 530 includes a list header 531. As stated previously, the respective page sections in the page 520₀ and the page 520₁, which are determined to correspond to the buffer 510, serve as an entry 532₀ and an entry 532₁ of the scatter-gather-list, respectively. Feature information of the determined page sections is stored in the list header 531. The feature information may include at least one of a start physical address of a page section, an end physical address of a page section, a size of a page section, and an associated page identifier.

According to some embodiments, the scatter-gather-list 530 may be transmitted to the QAT instance 330, such as a QAT device, to enable the QAT instance 330 to execute the compression or encryption operation for the data based on the scatter-gather-list.

The method for data processing as provided in the embodiments of the present disclosure can avoid the system performance bottleneck caused by the buffer copy operation in the conventional solution in the premise of satisfying the storage requirements put forward by the QAT, while providing a good compatibility for different platforms.

The latest platform Juno of Data Domain is used to test the solution as proposed in the present disclosure. The client A includes two Cisco C200 series servers with two dual-port 16 Gb Fiber-Channel Adapters. The objective is to cover a Juno 4 Tier Data Domain Restorer with 2 quad-port 16 Gb Fiber-Channel SLICs.

The perfload testing is an official test for DDFS performance benchmark. The testing covers writing and reading, simulating backup and restoring user cases. The perfload collects performance data during the testing. Here, a set of decompression data of one test case in perfload testing is taken as an example to implement testing of the implementation solution of the present disclosure.

The data in Table 1 shows decompression latency and throughput in a DFFS compressor component. All latency data in the table are average data. The QAT decompression latency stands for latency of QAT API. A buffer average size represents a data size after decompression—uncompressed data size. In the perfload testing, the compression rate is about 44%. Therefore, the compressed data size is around a half of the buffer average size, which is about 48 KB. As shown in Table 1, the conventional approach has to perform storage copy. The memory copy costs 67.337 μs in total. In the approach according to the present disclosure, there is no need of storage copy, but it is required to search virtual-to-physical translation cache, which will cost 4.805 μs. Consequently, the overall latency is 225.338 μs in the solution according to the present disclosure. As a result, the decompression throughput increases from 382.233 Mb/s to 491.466 MB/s, with a 28% improvement.

TABLE 1
Decompression Performance Statistics

| | Improved memory | Mempool |
|---|---|---|
| | pool | with copy buffer |
| QAT decompression latency (μs) | 220.533 | 222.541 |
| Src buffer memcopy latency (μs) | 0 | 17.563 |
| Dstbuffer memcopylatency (μs) | 0 | 49.774 |
| Overall latency (μs) | 225.338 | 289.878 |
| Buffer average size (KB) | 110.746 | 110.801 |
| Throughput (MB/S) | 491.466 | 382.233 |

Table 2 and Table 3 are to demonstrate performance improvement in a system level. Table 2 is to describe performance in compression intensive cases, and Table 3 is for decompression intensive cases. It can be seen that it lowers the CPU utilization by around 22% in both compression and decompression cases while even providing a higher throughput.

TABLE 2
Performance Comparison in Compression Intensive Case

| | Improved memory pool | Mempool with copy buffer |
|---|---|---|
| Throughput | 3519.99 | 3398.72 |
| (MB/S) | | |
| CPU utilization | 52.71% | 67.37% |

TABLE 3
Performance Comparison in Decompression Intensive Case

| | Improved memory pool | Mempool with copy buffer |
|---|---|---|
| Throughput | 6595.05 | 6051.68 |
| (MB/S) | | |
| CPU utilization | 45.25% | 58.51% |

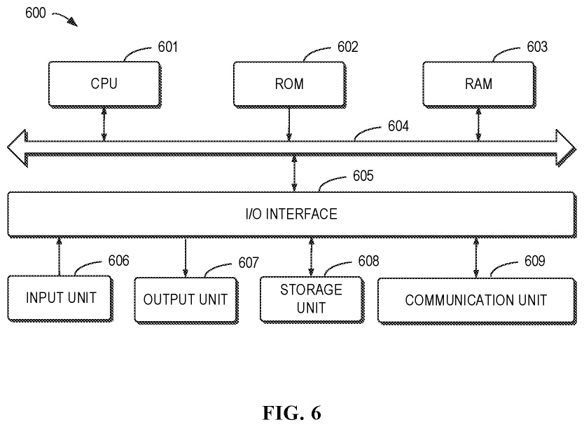

FIG. 6 illustrates a schematic diagram of a device 600 for implementing embodiments of the present disclosure. As shown, the device 600 includes a central processing unit (CPU) 601 that may perform various appropriate acts and processing based on computer program instructions stored in a read-only memory (ROM) 602 or computer program instructions loaded from a storage unit 608 to a random access memory (RAM) 603. In the RAM 603, there further store various programs and data needed for operations of the device 600. The CPU 601, ROM 602 and RAM 603 are connected to each other via a bus 604. An input/output (I/O) interface 605 is also connected to the bus 604.

The following components in the device 600 are connected to the I/O interface 605: an input unit 606, such as a keyboard, a mouse and the like; an output unit 607, such as various kinds of displays and a loudspeaker, etc.; a storage unit 608, such as a magnetic disk, an optical disk, and etc.; a communication unit 609, such as a network card, a modem, and a wireless communication transceiver, etc. The communication unit 609 allows the device 600 to exchange information/data with other devices through a computer network such as the Internet and/or various kinds of telecommunications networks.

Various processes and processing described above, e.g., the method 400, may be executed by the processing unit 601. For example, in some embodiments, the method 400 may be implemented as a computer software program that is tangibly embodied on a machine readable medium, e.g., the storage unit 608. In some embodiments, part or all of the computer programs can be loaded and/or mounted onto the device 600 via ROM 602 and/or communication unit 609. When the computer program is loaded to the RAM 603 and executed by the CPU 601, one or more steps of the method 400 as described above may be executed.

In conclusion, the embodiments of the present disclosure provide a method and device for data processing, which can avoid the system performance bottleneck caused by the buffer copy operation in the former solution in the premise of satisfying the storage requirements put forward by the QAT, while providing a good compatibility for different platforms.

The present disclosure is directed to a method, a device, a system and/or a computer program product. The computer program product may include a computer readable storage medium on which computer readable program instructions are carried out for performing each aspect of the present application.

The computer readable medium may be a tangible medium that may contain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. More specific examples (a non-exhaustive list) of the machine readable storage medium would include a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, device (apparatus), and computer program products according to embodiments of the disclosure. It would be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of data processing, comprising:
creating a memory pool for an application, the memory pool comprising at least one page with contiguous physical addresses;
determining information of a buffer for storing data of the application; and
in response to a compression or encryption operation to be executed for the data, determining, based on the information of the buffer, a page section of the at least one page corresponding to the buffer for the execution of the compression or encryption operation.

2. The method of claim 1, wherein creating the memory pool for the application comprises:
determining a mapping relationship between the physical address of the at least one page and a virtual address of the application; and
storing the mapping relationship as an entry of a cache.

3. The method of claim 2, wherein determining the mapping relationship comprises:
obtaining a start virtual address of the at least one page by mapping the at least one page to an address space of the application,
determining, at least in part based on the obtained start virtual address, a respective physical address of each page of the at least one page; and
generating the mapping relationship based on the determined physical address.

4. The method of claim 3, wherein determining the respective physical address of each page of the at least one page comprises:
reading a page mapping file in a file system, to translate the virtual address into the respective physical address.

5. The method of claim 1, wherein creating the memory pool for the application comprises:
locking the at least one page in the memory pool.

6. The method of claim 1, wherein determining the page section of the at least one page corresponding to the buffer comprises:
determining a start virtual address of the buffer and a size of the buffer;
determining a physical address based on the start virtual address; and
determining the page section of the at least page using the respective physical address and the size of the buffer.

7. The method of claim 1, further comprising:
determining feature information of the page section, the feature information comprising at least one of:
a start physical address of the page section,
an end physical address of the page section,
a size of the page section, and
an associated page identifier; and
transmitting the feature information of the page section to a QuickAssist Technology (QAT) device, to enable the QAT device to execute the compression or encryption operation for the data based on the feature information.

8. A device for data processing, comprising:
at least one processor; and
a memory coupled to the at least one processor and having an instruction stored therein, the instruction, when executed by the at least one processor, causing the device to perform a method, the method comprising:
creating a memory pool for an application, the memory pool comprising at least one page with contiguous physical addresses;
determining information of a buffer for storing data of the application; and
in response to a compression or encryption operation to be executed for the data, determining, based on the information of the buffer, a page section of the at least one page corresponding to the buffer for the execution of the compression or encryption operation.

9. The device of claim 8, wherein creating the memory pool for the application comprises:
determining a mapping relationship between the physical address of the at least one page and a virtual address of the application; and
storing the mapping relationship as an entry of a cache.

10. The device of claim 9, wherein determining the mapping relationship comprises:
obtaining a start virtual address of the at least one page by mapping the at least one page to an address space of the application,
determining, at least in part based on the obtained start virtual address, a respective physical address of each page of the at least one page; and
generating the mapping relationship based on the determined physical address.

11. The device of claim 10, wherein determining the respective physical address of each page of the at least one page comprises:
reading a page mapping file in a file system, to translate the virtual address into the respective physical address.

12. The device of claim 8, wherein creating the memory pool for the application comprises:
locking the at least one page in the memory pool.

13. The device of claim 8, wherein determining the page section of the at least one page corresponding to the buffer comprises:
determining a start virtual address of the buffer and a size of buffer;
determining a respective physical address based on the start virtual address; and
determining the page section of the at least page using the size of the buffer and the respective physical address.

14. The device of claim 8, further comprising:
determining feature information of the page section, the feature information comprising at least one of:
a start physical address of the page section,
an end physical address of the page section,
a size of the page section, and
an associated page identifier; and
transmitting the feature information of the page section to a QuickAssist Technology (QAT) device, to enable the QAT device to execute the compression or encryption operation for the data based on the feature information.

15. A computer program product, which is tangibly stored in a non-transient computer readable medium and includes at least one machine executable instruction, the at least one machine executable instruction, when executed, causing a machine to execute steps of the method.
creating a memory pool for an application, the memory pool comprising at least one page with contiguous physical addresses;
determining information of a buffer for storing data of the application; and
in response to a compression or encryption operation to be executed for the data, determining, based on the information of the buffer, a page section of the at least one page corresponding to the buffer for the execution of the compression or encryption operation.
